(19) United States
(12) Patent Application Publication
(10) Pub. No.: US 2026/0079263 A1
(43) Pub. Date: Mar. 19, 2026

(54) ELEVATION MASK LEARNING AND USE

(71) Applicant: QUALCOMM Incorporated, San Diego, CA (US)

(72) Inventors: Himaja KESAVAREDDIGARI, Bridgewater, NJ (US); Gene Wesley MARSH, San Diego, CA (US); Dan VASSILOVSKI, Del Mar, CA (US); Kapil GULATI, Belle Mead, NJ (US); Sourjya DUTTA, Jersey City, NJ (US)

(21) Appl. No.: 18/887,393

(22) Filed: Sep. 17, 2024

(51) Int. Cl. G01S 19/25; G01S 19/37; G01S 19/42

(52) U.S. Cl. CPC G01S 19/25; G01S 19/37; G01S 19/42

(57) ABSTRACT

A method for use in positioning of a user equipment, the method including: acquiring, at the user equipment, a first satellite vehicle signal from a first satellite vehicle of a plurality of satellite vehicles; obtaining, at the user equipment, ephemeris data from the first satellite vehicle signal; and providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

It is often desirable to know the location and/or motion (e.g., speed or velocity) of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

### SUMMARY

An example method for use in positioning of a user equipment includes: acquiring, at the user equipment, a first satellite vehicle signal from a first satellite vehicle of a plurality of satellite vehicles; obtaining, at the user equipment, ephemeris data from the first satellite vehicle signal; and providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

An example user equipment includes: at least one satellite positioning system (SPS) receiver; at least one memory; and at least one processor communicatively coupled to the at least one SPS receiver and the at least one memory and configured to: acquire, via the at least one SPS receiver, a first satellite vehicle signal from a first satellite vehicle of a plurality of satellite vehicles; obtain ephemeris data from the first satellite vehicle signal; and provide, to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

Another example user equipment includes: means for acquiring a first satellite vehicle signal from a first satellite vehicle of a plurality of satellite vehicles; means for obtaining ephemeris data from the first satellite vehicle signal; and means for providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

An example non-transitory, processor-readable storage medium includes processor-readable instructions to cause at least one processor of a user equipment to: acquire a first satellite vehicle signal from a first satellite vehicle of a plurality of satellite vehicles; obtain ephemeris data from the first satellite vehicle signal; and provide to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

An example elevation mask method includes: obtaining, at an entity, position information indicative of user equipment positions; obtaining, at the entity, elevation mask information corresponding to the user equipment positions and indicative of satellite vehicle visibility, if any, in a respective elevation angle range for each of a respective plurality of azimuth directions for each of the user equipment positions; and determining, at the entity, an elevation mask based on the elevation mask information.

An example apparatus includes: at least one receiver; at least one memory; and at least one processor communicatively coupled to the at least one receiver and the at least one memory and configured to: obtain position information indicative of user equipment positions; obtaining elevation mask information corresponding to the user equipment positions and indicative of satellite vehicle visibility, if any, in a respective elevation angle range for each of a respective plurality of azimuth directions for each of the user equipment positions; and determine an elevation mask based on the elevation mask information.

Another example apparatus includes: means for obtaining position information indicative of user equipment positions; means for obtaining elevation mask information corresponding to the user equipment positions and indicative of satellite vehicle visibility, if any, in a respective elevation angle range for each of a respective plurality of azimuth directions for each of the user equipment positions; and means for determining an elevation mask based on the elevation mask information.

Another example non-transitory, processor-readable storage medium includes processor-readable instructions to cause at least one processor of an apparatus to: obtain position information indicative of user equipment positions; obtain elevation mask information corresponding to the user equipment positions and indicative of satellite vehicle visibility, if any, in a respective elevation angle range for each of a respective plurality of azimuth directions for each of the user equipment positions; and determine an elevation mask based on the elevation mask information.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example user equipment.

FIG. 6 is a block diagram of an example network entity.

FIG. 7 is a block flow diagram of a top view of an example environment of a user equipment.

FIG. 8 is a side view of a user equipment between buildings.

FIG. 9 is a top view of a portion of the environment shown in FIG. 7 with a grid of location points for an elevation mask.

FIG. 10 is a table of location, azimuth angles, and minimum elevation angles for line-of-sight satellite vehicles.

FIG. 11 is a side view of buildings forming an urban canyon.

FIG. 12 is a signaling and process flow for learning and using an elevation mask.

FIG. 13 is a block flow diagram of a method for use in positioning of a user equipment.

FIG. 14 is a block flow diagram of an elevation mask method.

### DETAILED DESCRIPTION

Techniques are discussed herein for obtaining and using a geography-dependent elevation mask (which may also be called a variable elevation mask or a map-dependent elevation mask). An elevation mask of locations, azimuth angles, and corresponding elevation angles of unobstructed visibility (e.g., a potential line-of-sight (LOS) to satellite vehicle) or obstructed (occluded) visibility (e.g., a potential non-line-of-sight (NLOS) to satellite vehicle) may be learned, e.g., by crowdsourcing satellite vehicle (SV) signal measurements to determine signal strength and/or SV information (e.g., ephemeris data (including SV identity)). A learned elevation mask may be used, e.g., to predict Global Navigation Satellite System (GNSS) positioning quality and/or to improve a positioning solution (e.g., by identifying and discarding a potentially erroneous/inaccurate position estimate and re-computing the position estimate). These are examples, and other examples may be implemented.

Items and/or techniques described herein may provide one or more of the following capabilities, and possibly one or more other capabilities not mentioned. Elevation masks may be learned less expensively than by collection of and/or analysis of 2-D and/or 3-D map information. Elevation masks may be used to predict GNSS positioning quality. Elevation masks may be used to improve positioning solutions, e.g., by identifying erroneous/inaccurate position estimates and prompting determination of a new positioning solution. Elevation masks learned from satellite vehicle signal measurements (of signal strength (e.g., to determine line-of-sight/non-line-of-sight) and/or of SV data, as appropriate) may be used to predict blockage of line-of-sight and coverage for other Non-Terrestrial Networks (NTN) such as LEO networks (Low-Earth-Orbit networks). An elevation mask may be developed less expensively than by using a 3-D map, e.g., due to passive collection of information for determining the elevation mask. Precise orbital information from ephemeris data and frequent processing of GNSS satellite navigation messages at multiple UEs at multiple locations in a target area may provide a rich dataset from which elevation mask information may be determined. Almanac data may be used for a long time (e.g., weeks) by multiple UEs to obtain ephemeris data, which may be used to obtain accurate elevation mask information. The elevation mask information may include, for example, the lack of reception of an LOS signal from an SV and an indication of the azimuth and elevation angle of the SV for the UE location (based on the almanac information as to the location of the SV). Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

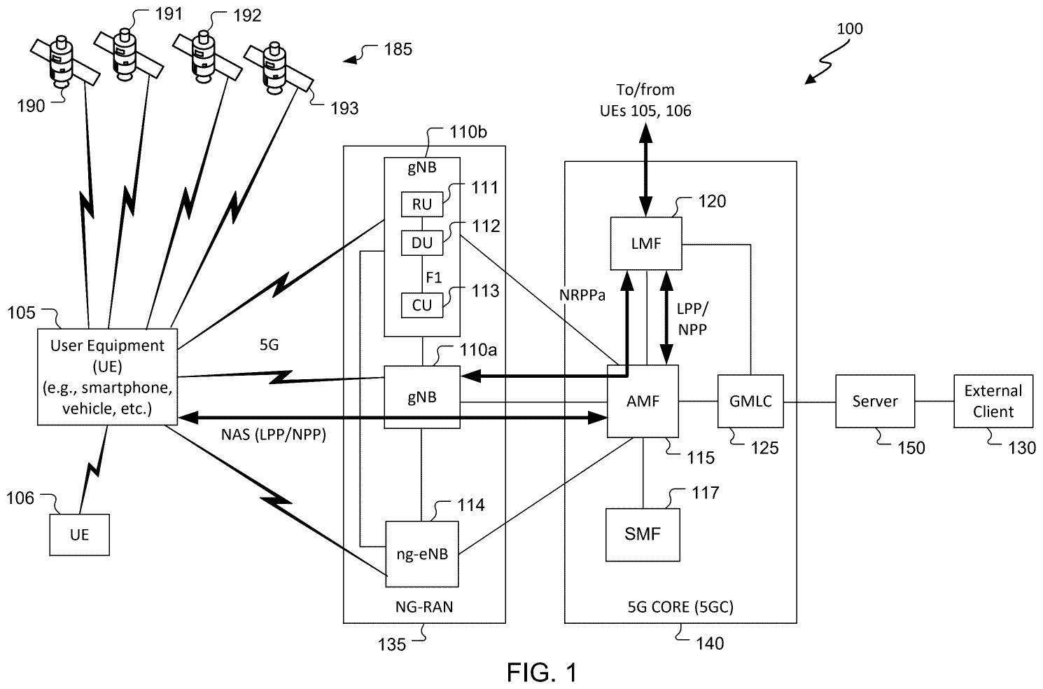

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

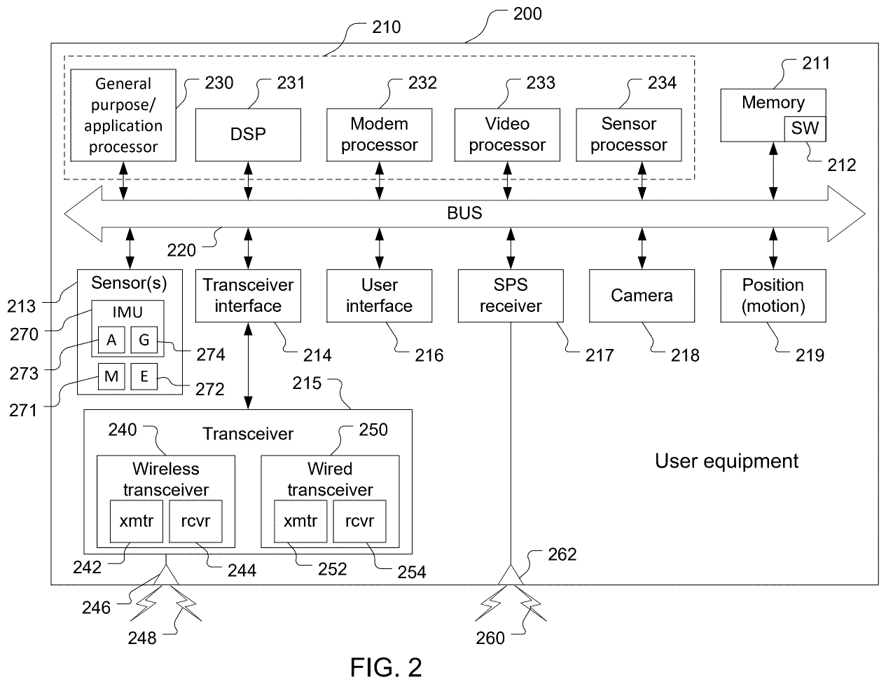

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

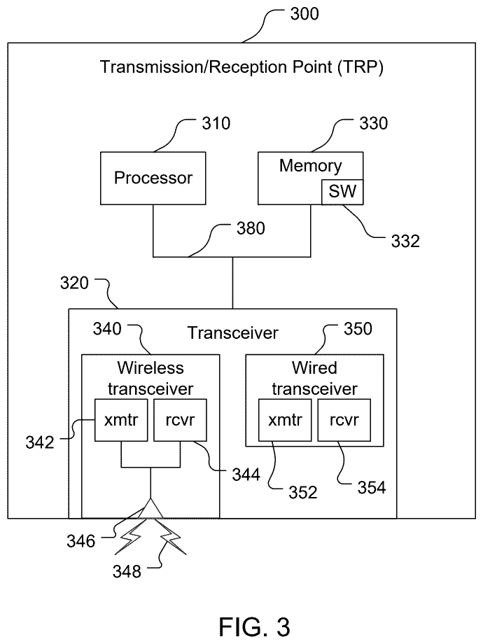

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and/or the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

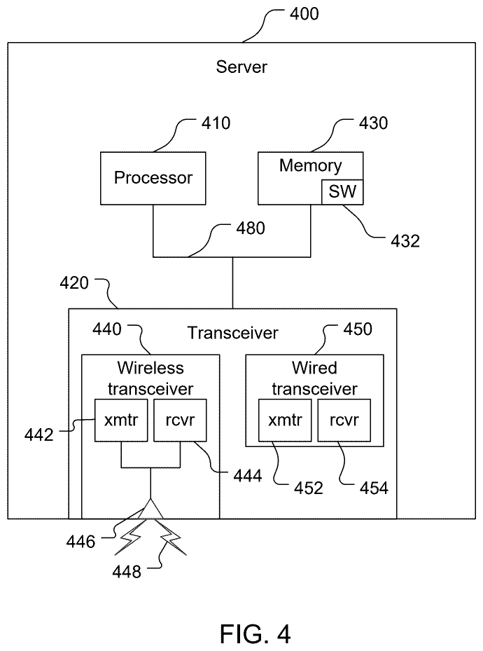

Referring also to FIG. 4, a server 400, of which the LMF 120 may be an example, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and/or the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120).

The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information - Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

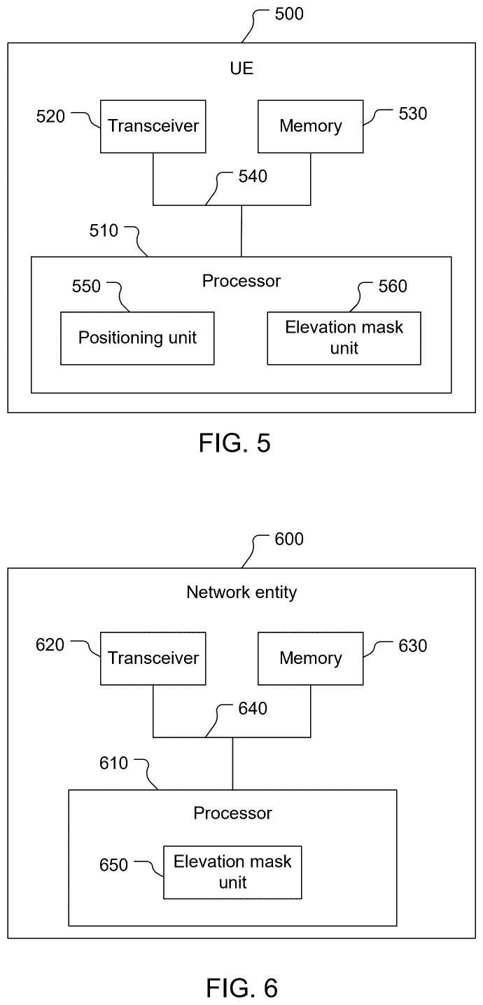

Referring also to FIG. 5, a UE 500 includes a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters and/or one or more receivers), and/or the memory 530 may include one or more memories. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. Also or alternatively, the transceiver 520 may include one or more other transmission and/or reception components, e.g., the SPS receiver 217 and the antenna 262. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a positioning unit 550 and an elevation mask unit 560. The positioning unit 550 may be configured to perform positioning operations (e.g., determine position information (e.g., measurements, pseudoranges, position estimates, etc.), e.g., from SV signals, other NTN (Non-Terrestrial Network) signals, terrestrial network signals, etc. The elevation mask unit 560 may be configured to determine and report information for learning, e.g., over time, an elevation mask. The positioning unit 550 and the elevation mask unit 560 are discussed further below, and the description may refer to the processor 510 generally, or the UE 500 generally, as performing any of the functions of the positioning unit 550 and/or the elevation mask unit 560, with the UE 500 being configured to perform the function(s).

Referring also to FIG. 6, a network entity 600 includes a processor 610, a transceiver 620, and a memory 630 communicatively coupled to each other by a bus 640. Even if referred to in the singular, the network entity 600 may include one or more network entities, the processor 610 may include one or more processors, the transceiver 620 may include one or more transceivers (e.g., one or more transmitters and/or one or more receivers), and/or the memory 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the network entity 600 may include one or more other components such as any of those shown in FIG. 3 such that the TRP 300 may be an example of the network entity 600. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include an elevation mask unit 650. The elevation mask unit 650 may be configured to instruct UEs to provide information for learning, and/or to learn and produce and elevation mask. The elevation mask unit 650 is discussed further below, and the description may refer to the processor 610 generally, or the network entity 600 generally, as performing any of the functions of the elevation mask unit 650, with the network entity 600 being configured to perform the function(s).

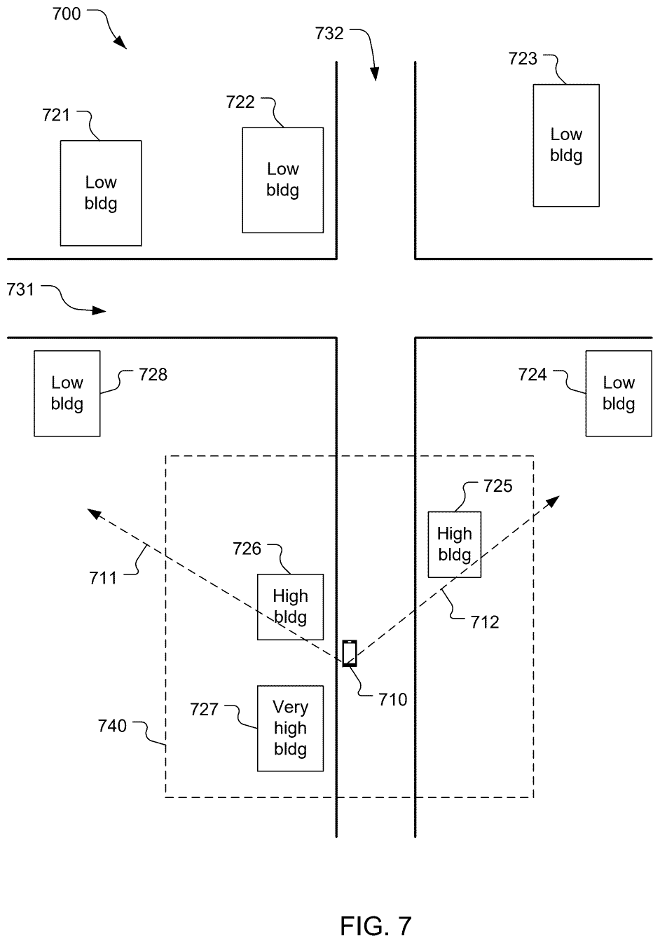

Referring to FIG. 7, an example environment 700 of a UE 710 includes various objects, some of which may present occlusions to SV signals for determining a position of the UE 710. In this example, the environment 700 includes buildings 721, 722, 723, 724, 725, 726, 727, 728 disposed about intersecting roads 731, 732. This is an example only, and infinite other environments may be used, including different quantities of buildings, objects in addition to buildings being present, different layouts of buildings and/or other objects, etc.

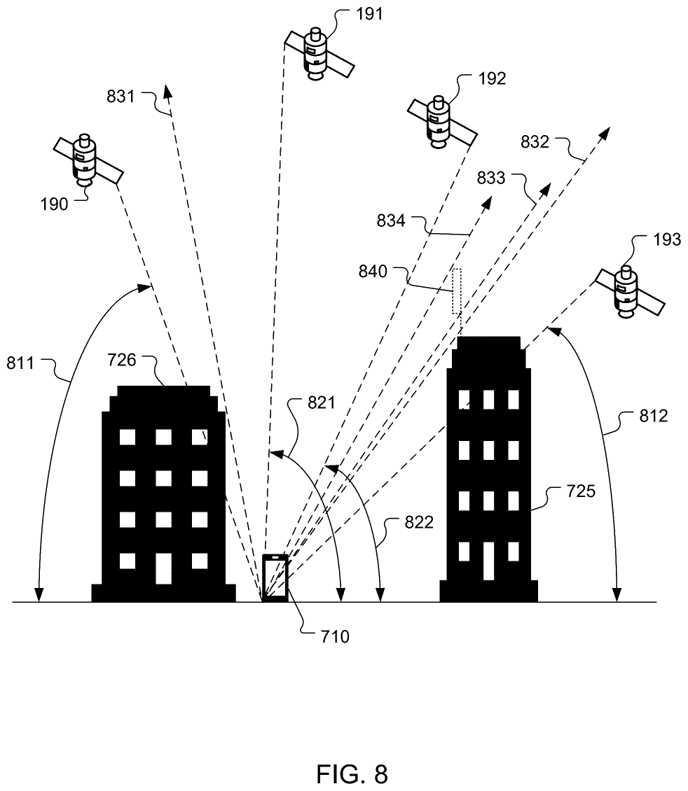

Referring also to FIG. 8, in environments such as the environment 700, especially environments including urban canyons, having information about visibility of SVs may be useful, e.g., in quickly acquiring SV signals and/or evaluating acquired SV signals and/or evaluating a position estimate based on SV signals. For example, the UE 710 may benefit from knowing that the SV 190 is presently occluded (and thus is non-line-of-sight (NLOS) relative to the UE 710) due to the SVs 190, 193 being at elevation angles 811, 812 and corresponding azimuth angles 711, 712 (FIG. 7) looking from the UE 710 through the buildings 726, 725, respectively. Techniques are discussed herein for characterizing whether LOS is feasible or infeasible for SVs from different locations and different azimuth angles at those locations.

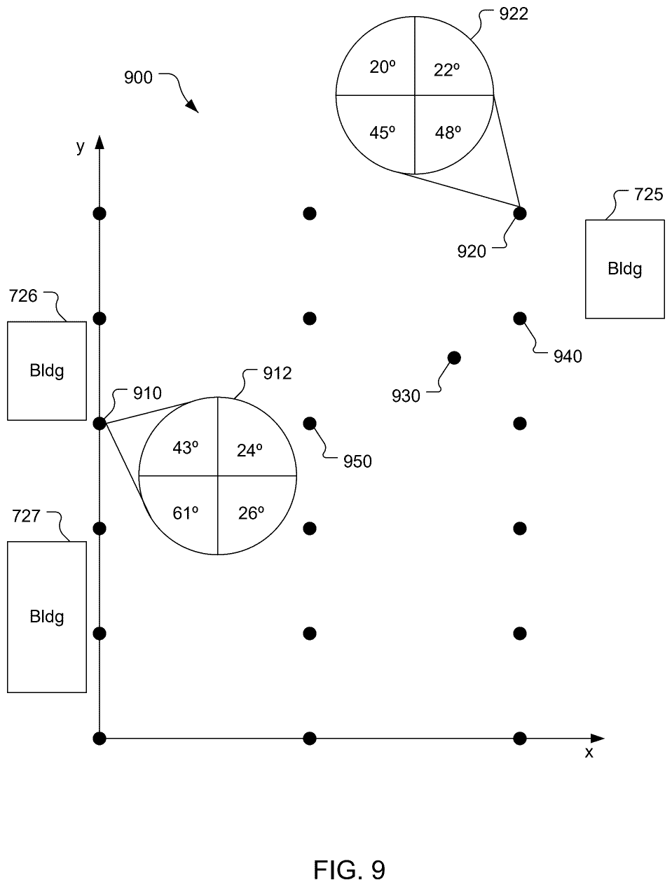

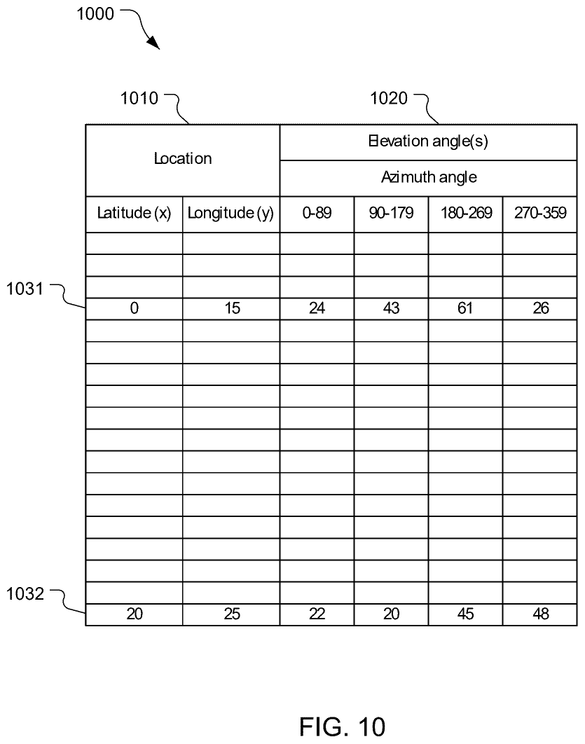

Referring also to FIG. 9 and FIG. 10, obtaining an elevation mask 1000 (also known as a sky plot) for a grid 900 of locations may be useful. The elevation mask 1000 in this example is for a region 740 shown in FIG. 4, which is divided into the grid 900 with locations of x-values (horizontal values) 0, 10, 30 and y-values (vertical values) 0, 5, 10, . . . 25. An elevation mask may indicate, for each of various locations (e.g., latitude/longitude combinations) and corresponding azimuth angles (e.g., ranges of azimuth angles), one or more ranges of elevation angles in which a satellite vehicle (SV) may be able to be seen (e.g., is not blocked by an occlusion). For example, an elevation angle may be indicated above which an SV may be visible (i.e., be within line of sight (LOS) of an indicated location (e.g., of an SV signal receiver)). The elevation mask 1000 indicates possible visibility of SVs at each of the different locations in the grid 900 and different azimuth angles. In this example, the azimuth angles are ranges from 0-89°, 90-179°, 180-269°, and 270-359°. One or more measurements may be made within each of these ranges in order to determine one or more corresponding elevation angles (e.g., one or more ranges of elevation angles). The elevation mask 1000 indicates locations 1010 and corresponding elevation angle(s) 1020 for respective azimuth angle(s). The elevation angle(s) may, for example, indicate one or more ranges of elevation angles for which an SV may be visible at some time (e.g., that is/are not occluded at the respective azimuth angle for the respective location). In the example shown in FIG. 9 and FIG. 10, sets 912, 922 of elevation angles for grid locations 910, 920 may correspond to four ranges of azimuth angles and have elevation values given in respective entries 1031, 1032. In this example, each elevation angle indicated is a single elevation angle indicating that at or above this elevation angle, SVs may be visible (i.e., in line-of-sight (LOS)). In this example, the elevation angles for the grid location 910 are 24°, 43°, 61°, and 26° corresponding to azimuth angles of ranges from 0-89°, 90-179°, 180-269°, and 270-359°. Also in this example, the elevation angles for the grid location 910 are 22°, 20°, 45°, and 48° corresponding to azimuth angles of ranges from 0-89°, 90-179°, 180-269°, and 270-359°. Elevation angles other than those indicated are occluded (or at least may be assumed to be occluded). Different forms of elevation masks other than the mask 1000 may be used, e.g., with explicit indications of occluded (NLOS) elevation angles acting as implicit indications of visible elevations angles instead of providing explicit indications of elevation angles of potentially visible satellite vehicles. A measurement may be made of an SV signal to determine received signal strength of an SV signal, e.g., to determine whether the SV is LOS or NLOS. A measurement may be made of an SV signal to determine data contained in the SV signal, e.g., ephemeris data, for determining elevation of the corresponding SV to determine elevation mask information.

Even if there are no occlusions in an environment (i.e., an open-sky environment), there is typically a lower limit for an elevation angle at which SVs may be visible. For example, an elevation angle at which SVs may be visible may be no lower than 15° due to distortion due to atmospheric effects.

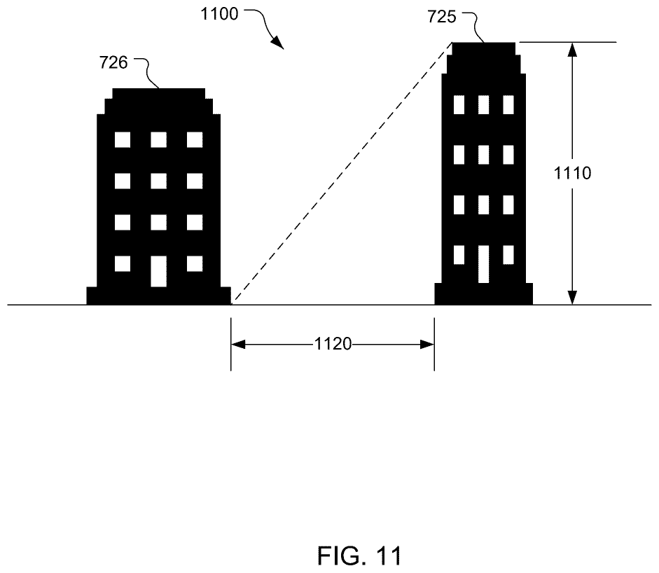

Referring to FIG. 7, FIG. 8, and FIG. 11, occlusions may exist in an environment of the UE 710, and such occlusions may cause poor GNSS positioning, e.g., in urban canyons. An environment (e.g., the terrain of the environment) may have the degree and nature of a canyon (i.e. canyon-ness) be quantified based on heigh-to-width (H/W) ratios. For example, as shown in FIG. 11, a canyon 1100 defined by the buildings 725, 726 may be defined by a height 1110 of the building 725 and a width 1120 between the buildings 725, 726. In an environment with occlusions (here buildings) of different heights, the canyon may be quantified using the height of the higher (highest) building, here the height 1110 of the building 725. Alternatively, a canyon may have different H/W ratios based on a location and orientation of the UE 710 and the road incline within the canyon. A canyon may be classified based on the H/W ratio. For example, a canyon may be classified as a shallow canyon (or canyon type 1) if the H/W ratio is less than or equal to 0.5, classified as a moderate canyon (or canyon type 2) if the H/W ratio is between 0.5 and 2.0, and classified as a deep canyon if the H/W ratio is greater than or equal to 2.0. Elevation masks are increased (restricted) in view of canyons. For example, even for a canyon with an H/W ratio of 1.2, the elevation restriction (i.e., the minimum elevation angle for potential LOS of an SV) may be as high as 50°, resulting in a GDoP (Geometric Dilution of Precision) of 6 or higher even with numerous (e.g., 100) satellites being available due to many of such satellites being occluded.

Existing metrics such as HEPE (Horizontal Estimated Position Error) and DoP (Dilution of Precision) may be unable to detect when instantaneous GNSS positioning is poor, even if such metrics may show good or poor GNSS positioning over time. A DoP less than 1 is considered ideal, between 1 and 2 is considered excellent, between 2 and 5 is considered good enough for making reliable decisions, and above 5 is considered unreliable.

Knowledge of an elevation mask such as the mask 1000 may provide several advantages. For example, an elevation mask may provide indications of occlusions including indications of canyons such as urban canyons, facilitating determination of a poor positioning estimate in the urban canyon if the number of LOS SVs falls below a required number (e.g., four) or facilitating determination of a poor positioning estimate in the urban canyon if the geometry of LOS SVs is not diverse (leading to greater dilution-of-precision and greater position error along one axis compared to others) or facilitating determination of LOS SVs such that sufficient (e.g., four or more) SV signals may be measured from LOS SVs of diverse spacing relative to a receiver. The elevation mask may be used to determine which SVs have LOS to a UE, which may be used to determine whether GNSS performance is likely to be good or poor. Canyons in a UE environment result in a restricted elevation mask (i.e., with limited elevation angles of potentially visible SVs), resulting in GNSS positioning being unreliable. This is true even for moderate canyons, with a height-to-width ratio between 0.5 and 2.0.

Previous techniques for obtaining an elevation mask have relied on obtaining three-dimensional (3-D) map information. For example, shadow matching algorithms rely on pre-existing 3-D map information and signal strength to determine LOS and an elevation mask. Shadow matching focuses on using the given 3-D map information and instantaneously improving positioning (especially in a cross-track direction, that is highly affected by the presence of canyons due to non-diverse geometry of LOS satellites in the cross-track direction). Unfortunately, 3-D map information may not be available and/or may be expensive to obtain (e.g., due to dedicated, active effort to obtain the map information, e.g., through surveying target areas). In the absence of 3-D map information, LOS SVs can be determined based on the received signal strengths and/or other measures. Determining the LOS SVs based on individual/isolated signal strength measurements may be challenging and carry a measure of uncertainty. Such uncertainty may be compensated for by obtaining a varied set of signal strength measurements that are verified against previous LOS predictions and elevation mask estimations to obtain a converged elevation angle solution.

Techniques are discussed herein for obtaining, e.g., learning, an elevation mask with or without previously-acquired map information (2-D or 3-D map information). For example, the network entity 600 in combination with one or more UEs, such as the UE 500, may be configured to learn one or more elevation masks each corresponding to a respective geographic region. For example, the elevation mask unit 650 of the network entity 600 may request elevation mask information from the UEs. The UEs, e.g., the positioning unit 550 of the UE 500, may obtain satellite ephemeris information and almanac information from SV signals and use this information to obtain position estimates of the UE 500 for respective locations. The UEs, e.g., the elevation mask unit 560 of the UE 500, may obtain elevation mask information, e.g., elevation angles that are not occluded for different locations and azimuth angles, and report the elevation mask information to the network entity 600. The network entity 600 may accumulate elevation information (for different positions and different azimuth angles for those positions) from the UE(s) to form one or more variable (map-dependent) elevation masks for one or more corresponding target areas. The UEs may determine, and the network entity 600 may learn, the elevation mask information without knowledge of map information (e.g., 3-D map information), or may use map information to help determine the elevation mask information. The network entity 600 may share the elevation mask(s) with one or more UEs. An elevation mask may be used to help determine a location of a UE. The elevation mask may be used, for example, to facilitate positioning of the UE(s) such as by predicting good or poor GNSS positioning performance and/or improving GNSS positioning performance as discussed further herein.

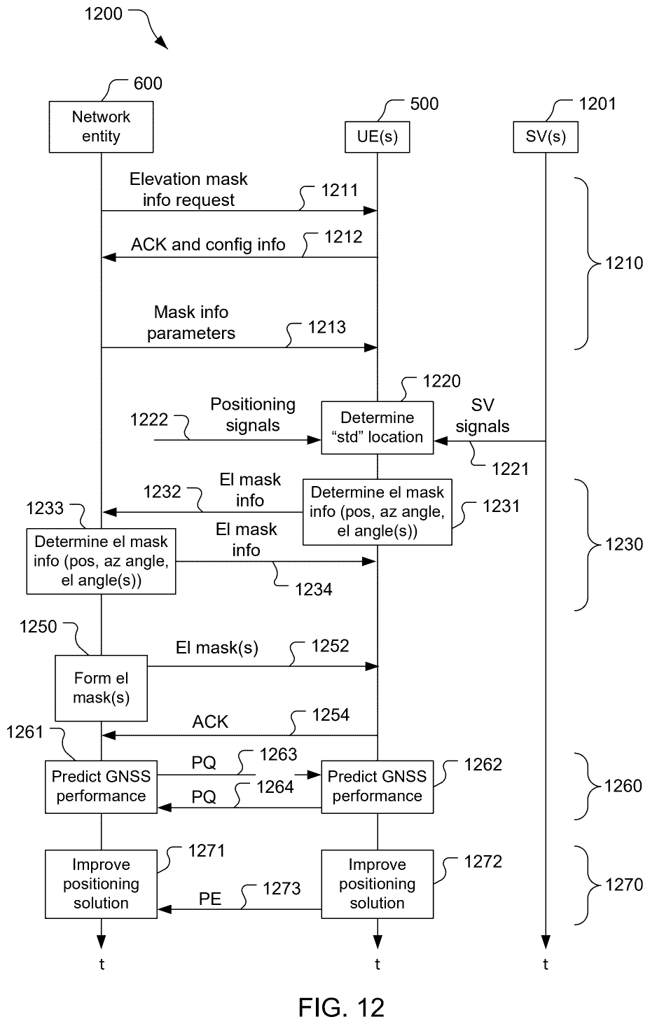

Referring also to FIG. 12, a signal and processing flow 1200 for learning and using an elevation mask includes stages shown. The flow 1200 is an example flow and not limiting. The flow 1200 may be altered, e.g., by having one or more messages and/or one or more stages added, removed, rearranged, combined, performed concurrently, and/or having one or more messages (where a request is a form of a message) and/or one or more stages split into multiple messages and/or stages. The description of the flow 1200 often refers to a UE or the UE 500, but the description is applicable to multiple UEs.

At stage 1210, initialization and configuration of data collection for learning an elevation mask are performed. The network entity 600 may transmit an elevation mask information request 1211 to initiate learning an elevation mask. The network entity 600, e.g., a cloud-based server, may transmit the request 1211 as a request for elevation mask estimation. The network entity 600 may send the request 1211 to the UE 500 via one or more intermediary devices, e.g., one of more of the TRPs 300. The UE 500 may respond to receiving the request 1211 by transmitting an acknowledgement (ACK) and device configuration information message 1212. The device configuration information may include, for example, memory type and/or capacity of the UE 500, processing capacity of the UE 500, and/or location of the UE 500, etc. The network entity 600 may transmit a mask information parameters message 1213 to the UE 500 and the UE 500 may receive the message 1213. The message 1213 may include grid-defining parameters for defining one or more grids of one or more elevation masks for one or more target areas, algorithm parameters for estimating an elevation mask, any map information (e.g., partial 2-D map information and/or partial 3-D map information (i.e., some, but not complete map information)) that is available, any converged elevation mask information, an indication to transmit estimated elevation mask information and other related outputs as such information/outputs become available, and/or criteria for accumulating and reporting (and/or for stopping to accumulate and/or report) estimated elevation mask information and other related outputs once the criteria are met. The network entity 600 may determine values for the grid-defining parameters based, for example, on the configuration (e.g., capacity) information provided by the UE 500 in the message 1212. The message 1213 may, for example, include either an indication to transmit estimated elevation mask information and other related outputs as such information/outputs become available, or criteria for accumulating and reporting estimated elevation mask information and other related outputs once the criteria are met. Other possible related outputs that the network entity 600 may indicate for the UE 500 to provide may include received SV signal strength, probability of an elevation angle being blocked (e.g., an estimate of the probability and a confidence of the estimate), and/or an indication of a location being in a canyon. The probability indication may indicate, for example, that an elevation angle determination for the corresponding location and azimuth angle is not yet converged, and that based on the non-converged solution there is an X % chance that elevations below angle Z° are blocked, i.e., occluded and are thus NLOS for any potential SVs on the indicated angle(s) (and/or a Y % chance that elevations at or above angle Z° are not blocked, i.e., not blocked and are thus LOS for any potential SVs on the indicated angle(s)).

Grid-defining parameters may include one or more indications of position granularity and/or azimuth-angle granularity. The grid granularity parameter(s) may include increment values for three-dimensional spacing of locations for which elevation mask information is desired. The azimuth angle granularity parameter(s) may include one or more indications of azimuth angles, e.g., azimuth angle ranges such as discussed with respect to FIG. 9 and FIG. 10. Grid granularity parameter values may be different for different target areas, e.g., being more coarse for rural areas (e.g., open-sky areas) than for more dense areas (with more occlusions). For example, horizontal (latitude) and/or vertical (longitude) increments for grid points may be 10 m or even 100 m for a rural target area, and much smaller, e.g., 1 m, for an urban target area.

Algorithm parameters in the message 1213 may provide machine-learning (ML) parameters and/or non-ML parameters to be used for estimating elevation mask values (e.g., elevation angles of LOS SVs and/or NLOS SVs), estimating GNSS positioning quality, improving GNSS positioning, etc. For example, such parameters may include one or more LOS/NLOS determination parameters (e.g., a threshold for received signal strength (e.g., 40 dB/Hz) of an SV signal indicative of a corresponding SV being LOS) and/or an uncertainty metric for assigning an SV as LOS or NLOS), and/or one or more convergence criteria (e.g., a maximum number of iterations for estimating an elevation angle for a single location and corresponding azimuth angle (range)). The LOS/NLOS parameters may be used in one or more LOS/NLOS determination algorithms to determine whether a particular SV is LOS or NLOS at a particular location, azimuth angle, and elevation angle. The azimuth angle and elevation angle may be determined from the ephemeris data and the present estimated location of the UE 500.

The message 1213 may include criteria for accumulating and reporting estimated elevation mask information and other related outputs once the criteria are met. For example, such criteria may include a time interval over which to obtain elevation mask information (e.g., obtain and process SV signal measurements) before reporting the elevation mask information, a maximum amount of memory to use to store elevation mask information before reporting such information, an indication to report elevation mask information in response to acquiring/re-acquiring good network connectivity, an indication to report elevation mask information before leaving a target area, and/or an indication to report elevation mask information in response to convergence of such information (e.g., an elevation mask angle, and/or other desired output, for a respective azimuth angle and location).

At stage 1220, the UE 500, e.g., the positioning unit 550, determines a location of the UE 500. For example, the positioning unit 550 may determine a “standard” location estimate and metrics related to the location estimate. The positioning unit 550 may determine the standard (or initial) location estimate using one or more GNSS signals 1221, from one or more SVs 1201, and/or one or more positioning signals 1222 from one or more other signal sources (e.g., TRPs, anchor UEs, etc.) using one or more known techniques (e.g., as discussed above). The positioning unit 550 may determine metrics such as estimated error (e.g., HEPE, EHPE (Estimated Horizontal Position Error), DoP), estimated uncertainty, estimated confidence, etc. The positioning unit 550 may determine a grid-based position of the UE 500 based on the standard location estimate and the grid-defining parameters received from the network entity 600 in the mask information parameters message 1213. The UE 500 may transmit SV signal information, e.g., SV signal measurements, ephemeris data from the SV signals 1221, and/or almanac information from the SV signals 1221 to the network entity 600.

At stage 1230, elevation mask information may be determined by the UE 500, e.g., the elevation mask unit 560, at sub-stage 1231 and/or the network entity 600, e.g., the elevation mask unit 650, at sub-stage 1233 based on at least the SV signals 1221.

For example, at sub-stage 1231 the elevation mask unit 560 may use one or more values, e.g., a combination of the location determined at stage 1220, ephemeris data from the SV signals 1221, almanac data from the SV signals 1221, signal reception and/or lack thereof, received signal strengths of the SV signals 1221, any available map information (2-D or 3-D), and/or any available converged elevation mask data, etc., to determine elevation mask information. The ephemeris data provides highly-precise orbital information for the SV that transmitted the SV signal. The ephemeris data may be used to determine an azimuth angle and an elevation angle to the transmitting SV based on the position estimate of the UE 500 (e.g., the UE 710). The almanac data provides slightly less-precise data than the ephemeris data for (all) satellites in the same constellation as the satellite from which an SV signal is received, and may be used, for example, to assist with acquisition of other SV signals from other SVs. A reason for using GNSS signals (as opposed to signals from other NTN networks) to determine elevation mask information as discussed herein is the availability of almanac data remains useful for weeks after acquiring the almanac data. Once obtained, however, the elevation mask data may be used for other NTN networks such as LEO satellites. The elevation mask unit 560 may determine the elevation mask information using one or more ML and/or non-ML algorithms. The determined mask information may include one or more ranges of elevation angles for potentially LOS SVs corresponding to a location and an azimuth angle (e.g., (x, y, Φ)), e.g., for multiple locations and multiple azimuth angles at each location. The determined mask information may include, e.g., based on the determined elevation angles and separation(s) of occlusions, an indication of whether a corresponding location is in a canyon.

The UE 500 may transmit an elevation mask information message 1232 to the network entity 600 in accordance with the instructions contained in the message 1213. For example, the UE 500 may transmit the elevation mask information message 1232 as the elevation mask information becomes available, or may transmit the elevation mask information when one or more criteria specified in the message 1213 are met. The elevation information provided in the elevation mask information message 1232 may include determined elevation angles for potentially LOS SVs and related outputs, quality of a location estimate of the UE 500, an indication of whether the UE 500 is in a canyon, a certainty that an elevation angle (for a corresponding UE location and azimuth angle (e.g., (x, y, Φ)) is blocked or not blocked, and/or information for the network entity 600 to use to determine the elevation angles for potentially LOS SVs.

To determine elevation angles for (geometry of) potentially LOS SVs, the UE 500 and/or the network entity 600 may determine whether a received SV signal is received from an LOS SV and information regarding SVs from which SV signals are not received. Known techniques may be used to determine whether a received SV signal is from an LOS SV (e.g., analyzing received signal strength). The determined elevation mask information may include, for various azimuth angles for a UE location, information as to from which of the SV(s) 1201 an SV signal is received, which of the SV(s) 1201 are LOS with the UE 500 (at the present location and at a particular azimuth angle), information as to from which of the SV(s) 1201 an SV signal is not received, and an estimate of one or more ranges of elevation angles for LOS or NLOS SVs, e.g., an elevation angle above which SVs are expected to be visible (LOS), e.g., an elevation angle 821 corresponding to the SV 191 and an elevation angle 822 corresponding to the SV 192 as shown in FIG. 8. As more locations are evaluated, more SV signals are received from LOS SVs, and more SV signals from NLOS SVs are not received and noted, the elevation mask unit 560 may converge on elevation angles for potential LOS SVs and elevation angles for NLOS SVs for each grid location and azimuth angle combination. For example, the elevation mask unit 560 and/or the elevation mask unit 650 may determine that elevation angles corresponding to rays 831, 832 shown in FIG. 8 for respective azimuth angles correspond to dividing elevation angles between potentially LOS SVs and NLOS SVs. There may be zero, one, or more than one ranges of angles where SVs are potentially LOS for a given azimuth angle. For example, as shown in FIG. 8, elevation angles above the angle corresponding to the ray 831 are LOS angles for SVs. As another example, elevation angles between an angle corresponding to the ray 832 and a ray 833, and elevation angles above an angle corresponding to a ray 834, may be LOS angles for SVs. Elevation angles between the rays 833, 834 may be NLOS (occluded) angles due to a billboard 840 disposed above the building 725. The elevation angles and corresponding azimuth angles are mapped to appropriate locations on the pre-defined grid. The network entity 600 may transmit elevation mask information to the UE 500 in an elevation mask information message 1234, e.g., to provide information that the UE 500 (e.g., the elevation mask unit 560) may use to determine one or more elevation masks. The elevation mask information message 1234 may include one or more indications that elevation mask information for a particular location (and possibly one or more azimuth angles) has converged, e.g., that new information for that location (and azimuth angle) does not change elevation angle information (e.g., an elevation angle above which SVs will be LOS) more than a threshold amount (a threshold angle delta). The one or more indications in the elevation mask information message 1234 of convergence may be an implicit instruction, and/or may include an explicit instructions, for the UE 500 to stop reporting elevation mask information for that location (and azimuth angle), and/or to stop gathering elevation mask information for that location (and azimuth angle).

At stage 1250, the network entity 600 (e.g., the elevation mask unit 650) forms one or more elevation masks for one or more corresponding target areas. The network entity 600 collects elevation mask information from the UE 500, and possibly other UEs, to learn elevation angles for potentially LOS SVs for the grid points and corresponding azimuth angles of one or more target areas. The elevation mask may be developed less expensively than by using a 3-D map, e.g., due to passive collection of information for determining the elevation mask (e.g., obtaining GNSS navigation messages/SV signals that would be obtained even if an elevation mask is not to be determined). The availability of precise orbital information from ephemeris data as part of satellite navigation messages and frequent processing of GNSS satellite navigation messages at multiple UEs at multiple locations in a target area help provide a rich dataset from which elevation mask information may be determined. The network entity 600 may map provided elevation mask and related outputs computed by one or more UEs to grid locations (e.g., interpolating data provided for locations other than grid locations, e.g., interpolating less-granular data points for more-granular grid points of an elevation mask). The network entity 600 may perform the mapping while accounting for compression (upsampling of x, y, azimuth), etc. The network entity 600 may de-weight information provided by the UE 500, e.g., applying less weight (significance) to elevation mask information (e.g., in an ML algorithm) based on the UE 500 having low elevation mask determination capability (e.g., low elevation angle determination accuracy and/or confidence), and/or based on disparity between points of an elevation mask and a location corresponding to reported elevation mask information (which may be called a reported location). For example, reported information corresponding to a reported location 930 (see FIG. 9) that is proximate to, but separate from, an elevation mask grid point (e.g., a grid point 940) may be de-weighted, with the reported information being de-weighted more the further the reported location is from the elevation mask grid point to which the elevation mask information is mapped. A reported location may be different from an elevation mask grid location for one or more of a variety of reasons, e.g., granularities of the elevation mask and a reporting grid being different, and/or grid centers (grid locations/points) being different between the elevation mask and a reporting grid. The network entity 600, using information from the UE(s), provides cloud-based, crowd-sourced elevation mask learning. The network entity 600 may transmit an elevation mask message 1252 to the UE 500 (e.g., in response to the UE 500 entering a target area) to provide one or more elevation masks indicating locations, corresponding azimuth angles, and corresponding LOS and/or NLOS elevation angles for SVs (i.e., angles at which an SV may be LOS or will be NLOS, respectively) for one or more respective target areas. The elevation mask message 1252 may serve as an implicit instruction, or may include an explicit instruction, for the UE 500 to stop elevation mask estimation and/or to stop providing the elevation mask information message 1232, at least with respect to one or more grid points. The UE 500 may respond to receiving the instruction by sending an acknowledgement message 1254 to the network entity 600.

At stage 1260, the network entity 600 (at sub-stage 1261) and/or the UE 500 (at sub-stage 1262) may predict GNSS positioning performance using the elevation mask for a target area. For example, for each UE, the network entity 600 and/or the UE 500 may estimate the quality of GNSS positioning based on the elevation mask for the corresponding target area. The network entity 600 and/or the UE 500 may, for example, use a converged solution of the elevation mask for a selected grid point, the ephemeris data, and the almanac data to determine the geometry of SVs within line-of-sight of the location for the selected grid point. This determined geometry may be used to determine a quality of a location estimate determined based on the SV signals 1221, e.g., by determining a geometric diversity of the LOS SVs for the location estimate, with higher geometric diversity (e.g., four or more LOS SVs disposed at different locations in the sky) corresponding to better GNSS positioning performance (e.g., accuracy), and low geometric diversity (e.g., less than four LOS SVs with significant geometric diversity) corresponding to poor GNSS positioning performance. The UE 500 may report GNSS positioning quality to the network entity 600 or keep this information within the UE 500. The network entity 600 may transmit a positioning-quality message 1263 including a positioning-quality indication indicating a quality of a position estimate for the UE 500. The UE 500 may transmit a positioning-quality message 1264 including a positioning-quality indication indicating a quality of a position estimate for the UE 500.

At stage 1270, the network entity 600 (at sub-stage 1271) and/or the UE 500 (at sub-stage 1272) may improve a positioning solution based on an elevation mask. The network entity 600 and/or the UE 500 may, for example, use a converged solution of the elevation mask for a selected grid point, the ephemeris data, and the almanac data to determine whether there are any mismatches between satellite vehicles expected to be LOS for “standard” UE position estimates and the satellite vehicles determined to be LOS to the UE 500 based on received SV signals corresponding to the standard UE position estimates (i.e., based on SV signals received substantially concurrently with signals received and used to determine the standard UE position estimate). If there is a mismatch in expected and actual LOS SVs, then the position estimate for the UE 500 may be indicated (internally to the UE 500 and/or externally, e.g., to the network entity in a position-error message 1273) determined to be inaccurate and may be re-determined (e.g., using an ML algorithm and/or a non-ML algorithm) based on the SVs determined to be LOS based on received SV signals, and treating any other SV as NLOS (even if the elevation mask indicates such an SV to be LOS).

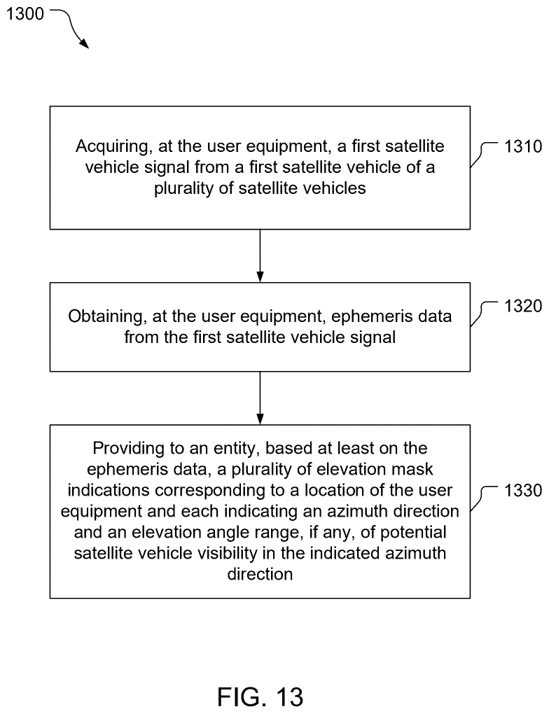

Referring to FIG. 13, with further reference to FIGS. 1-12, a method 1300 for use in positioning of a user equipment includes the stages shown. The method 1300 is, however, an example only and not limiting. The method 1300 may be altered, e.g., by having one or more stages added, removed, rearranged, combined, performed concurrently, and/or by having one or more single stages split into multiple stages.

At stage 1310, the method 1300 includes acquiring, at the user equipment, a first satellite vehicle signal from a first satellite vehicle of a plurality of satellite vehicles. For example, at stage 1220 the UE 500 acquires one or more of the SV signals 1221. Referring to FIG. 2 and FIG. 5, the processor 510, possibly in combination with the memory 530 (e.g., the processor 210, possibly in combination with the memory 211), in combination with a receiver (e.g., the SPS receiver 217) of the transceiver 520 may comprise means for acquiring the first satellite vehicle signal.

At stage 1320, the method 1300 includes obtaining, at the user equipment, ephemeris data from the first satellite vehicle signal. For example, at stage 1230 the UE 500 extracts ephemeris data from the first satellite vehicle signal acquired at stage 1220. Referring to FIG. 2 and FIG. 5, the processor 510 (e.g., the processor 210), possibly in combination with the memory 530 (e.g., the memory 211), may comprise means for obtaining ephemeris data from the first satellite vehicle signal.

At stage 1330, the method 1300 includes providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction. For example, the processor 510 (e.g., the processor 210) may provide elevation mask information (e.g., a UE location estimate, an azimuth angle, and an elevation angle to an LOS SV) internally to the UE 500, e.g., from (one portion of) the processor 510 to (another portion of) the processor 510 for further processing, or from the processor 510 to the memory 530, etc. Also or alternatively, the processor 510 (e.g., the processor 210) may provide elevation mask information to the network entity 600 in the elevation mask information message 1232. Referring to FIG. 2 and FIG. 5, the processor 510 (e.g., the processor 210), possibly in combination with the memory 530 (e.g., the memory 211), may comprise means for providing the plurality of elevation mask indications. The processor 510 (e.g., the processor 210), possibly in combination with the memory 530 (e.g., the memory 211), in combination with a transmitter of the transceiver 520 (e.g., the wireless transmitter 242 and the antenna 246) may comprise means for providing the plurality of elevation mask indications.

Implementations of the method 1300 may include one or more of the following features. In an example implementation, the method 1300 includes transmitting a positioning-quality indication, based on the ephemeris data and the plurality of elevation mask indications. For example, at stage 1260 (sub-stage 1262) the UE 500 may internally transmit an indication of GNSS positioning quality and/or may transmit the positioning-quality message 1263 indicating a quality of GNSS positioning. The processor 510, possibly in combination with the memory 530, may comprise means for transmitting the positioning-quality indication. Referring to FIG. 2 and FIG. 5, the processor 510 (e.g., the processor 210), possibly in combination with the memory 530 (e.g., the memory 211), in combination with a transmitter of the transceiver 520 (e.g., the wireless transmitter 242 and the antenna 246) may comprise means for transmitting the positioning-quality indication.

Also or alternatively, implementations of the method 1300 may include one or more of the following features. In an example implementation, providing the plurality of elevation mask indications comprises wirelessly transmitting the plurality of elevation mask indications from the user equipment to a network entity. For example, at sub-stage 1231 the UE 500 may transmit the elevation mask information message 1232 to the network entity. Referring to FIG. 2 and FIG. 5, the processor 510 (e.g., the processor 210), possibly in combination with the memory 530 (e.g., the memory 211), in combination with a transmitter of the transceiver 520 (e.g., the wireless transmitter 242 and the antenna 246) may comprise means for transmitting the plurality of elevation mask indications. In a further example implementation, transmitting the plurality of elevation mask indications comprises transmitting each of the plurality of elevation mask indications in response to determination of the elevation angle range of each of the plurality of elevation mask indications. For example, at sub-stage 1231 the UE 500 may transmit the elevation mask information message 1232 as elevation mask information becomes available (e.g., is determined by the UE 500), e.g., without accumulating the elevation mask information and waiting for one or more accumulation criteria indicated by the network entity 600 to be met before transmitting the message 1232. In another further example implementation, transmitting the plurality of elevation mask indications comprises transmitting the plurality of elevation mask indications in response to one or more reporting criteria, specified by the network entity to the user equipment, being met. For example, at sub-stage 1231 the UE 500 may transmit the elevation mask information message 1232 only after one or more reporting criteria indicated by the network entity 600 (e.g., in the mask information parameters message 1213) are met. In a further example implementation, the one or more reporting criteria comprise at least one of: passage of a time interval; a specified amount of user equipment memory limit for storing the plurality of elevation mask indications being reached; acceptable levels of connectivity of the user equipment to a network of the network entity; departure of the user equipment from a geographic region of interest; or convergence of the plurality of elevation mask indications. Departure of the UE from a region of interest may trigger reporting elevation mask information, e.g., to help ensure that elevation mask information determined by the UE 500 is obtained by the network entity 600 for a desired region (e.g., before the UE 500 is out of range for reporting the information).

Also or alternatively, implementations of the method 1300 may include one or more of the following features. In an example implementation, the method 1300 further includes providing a location-error indication based on a disparity between which of the plurality of satellite vehicles the plurality of elevation mask indications indicate are not visible at the location of the user equipment and which of the plurality of satellite vehicles are visible to the user equipment. For example, at stage 1270 (sub-stage 1272) the UE 500 may provide (internally and/or to the network entity 600 in the message 1273) an indication of whether a determined location disagrees with observed data, e.g., based on an SV expected to be LOS at a determined location of the UE 500 but the SV not being LOS.

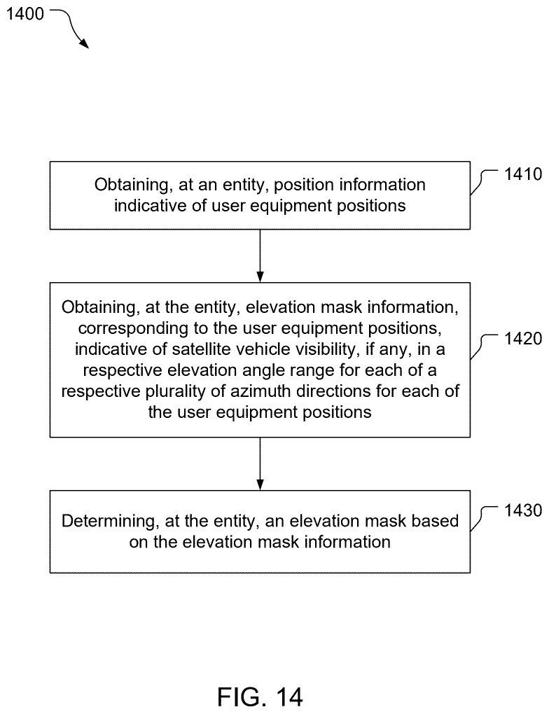

Referring to FIG. 14, with further reference to FIGS. 1-12, an elevation mask method 1400 includes the stages shown. The method 1400 is, however, an example only and not limiting. The method 1400 may be altered, e.g., by having one or more stages added, removed, rearranged, combined, performed concurrently, and/or by having one or more single stages split into multiple stages.

At stage 1410, the method 1400 includes obtaining, at an entity, position information indicative of user equipment positions. For example, at stage 1220 the UE 500 (e.g., the positioning unit 550) may obtain positioning signal measurements and/or determine a position estimate for the UE 500. As another example, at stage 1230 the network entity 600 may obtain positioning signal measurements and/or a position estimate for the UE 500 in the elevation mask information message 1232. The processor 510, possibly in combination with the memory 530, possibly in combination with a receiver (e.g., the SPS receiver 217 and/or the wireless receiver 244 and the antenna 246) of the transceiver 520 may comprise means for obtaining the position information. Also or alternatively, the processor 610, possibly in combination with the memory 630, in combination with a receiver (e.g., the wireless receiver 444 and the antenna 446, or the wired receiver 454) of the transceiver 620 may comprise means for obtaining the position information.

At stage 1420, the method 1400 includes obtaining, at the entity, elevation mask information corresponding to the user equipment positions and indicative of satellite vehicle visibility, if any, in a respective elevation angle range for each of a respective plurality of azimuth directions for each of the user equipment positions. For example, at sub-stage 1231 the UE 500 may determine the elevation mask information (e.g., based on one or more received SV signals and/or SV signals not received and corresponding SV locations). As another example, the network entity 600 may receive the elevation mask information in the message 1232 and/or determine some or all of the elevation mask information at sub-stage 1233 based on information received in the message 1232. The elevation mask information may, for example, be an indication of measurement of an LOS signal from a particular SV, or an indication of azimuth and elevation angles and reception of an LOS SV signal, or a signal strength and azimuth and elevation angles, or a signal strength and an indication of the SV, etc. The processor 510, possibly in combination with the memory 530, possibly in combination with a receiver (e.g., the SPS receiver 217) of the transceiver 520 may comprise means for obtaining the elevation mask information. Also or alternatively, the processor 610, possibly in combination with the memory 630, in combination with a receiver (e.g., the wireless receiver 444 and the antenna 446, or the wired receiver 454) of the transceiver 620 may comprise means for obtaining the elevation mask information.

At stage 1430, the method 1400 includes determining, at the entity, an elevation mask based on the elevation mask information. For example, at stage 1250 the network entity 600 may determine one or more elevation masks. The UE 500 may determine one or more elevation masks, but the network entity 600 may be able to do so quicker by obtaining elevation mask information from multiple UEs. The processor 510, possibly in combination with the memory 530, may comprise means for determining the elevation mask. Also or alternatively, the processor 610, possibly in combination with the memory 630, may comprise means for determining the elevation mask.

Implementations of the method 1400 may include one or more of the following features. In an example implementation, the entity is a network entity, and the method 1400 further includes transmitting, from the entity to a user equipment, an instruction to report respective elevation mask information. For example, at stage 1210 the network entity 600 may transmit the mask information parameters message 1213 instructing the UE 500 to report elevation mask information (e.g., as the UE 500 determines (e.g., as soon as possible after determining) the elevation mask information). The processor 610, possibly in combination with the memory 630, in combination with a transmitter (e.g., the wireless transmitter 442 and the antenna 446, or the wired transmitter 452) of the transceiver 620 may comprise means for transmitting the instruction. In another example implementation, the entity is a network entity, and the method 1400 further includes transmitting, from the entity to a user equipment, an instruction to report respective elevation mask information in response to one or more reporting criteria being met. For example, at stage 1210 the network entity 600 may transmit the mask information parameters message 1213 instructing the UE 500 to report elevation mask information only after one or more reporting criteria are met (e.g., one or more criteria for accumulating elevation mask information). The processor 610, possibly in combination with the memory 630, in combination with a transmitter (e.g., the wireless transmitter 442 and the antenna 446, or the wired transmitter 452) of the transceiver 620 may comprise means for transmitting the instruction. In a further example implementation, the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

Also or alternatively, implementations of the method 1400 may include one or more of the following features. In an example implementation, determining the elevation mask comprises mapping a first location estimate of a user equipment corresponding to a portion of the elevation mask information to a second location in the elevation mask. For example, the network entity 600 may take coarse elevation mask information (e.g., corresponding to less-dense UE locations than in an elevation mask being determined by the network entity 600) and map the coarse elevation mask information (corresponding to a first location) to the elevation mask, e.g., to a respective second location (a grid point in the elevation mask). The second location may be separate from the first location. The information corresponding to the second location may be assigned greater weightage if the second location is proximate to the first location. The second location may be considered proximate to the first location if, for example, the second location is within an elevation mask granularity of the first location (i.e., is separated by less than a maximum separation of adjacent grid points (e.g., diagonally-separated grid points such as the grid point 940 and a grid point 950)). The processor 610, possibly in combination with the memory 630, may comprise means for mapping the first location estimate to the second location. In a further example implementation, the method 1400 includes assigning weightage to the portion of the elevation mask information based on a relationship of the first location estimate to the second location. For example, the elevation mask unit 650 may cause elevation mask information associated with a location not corresponding to an elevation mask grid point to have less influence on an elevation mask than elevation mask information corresponding to an elevation mask grid point. The processor 610, possibly in combination with the memory 630, may comprise means for de-weighting the portion of the elevation mask information.

Also or alternatively, implementations of the method 1400 may include one or more of the following features. In an example implementation, the method 1400 includes de-weighting the elevation mask information based on an elevation mask determination capability of a user equipment reporting the elevation mask information. For example, the elevation mask information may be de-weighted more the lower the accuracy capability of the UE reporting the elevation mask information. The processor 610, possibly in combination with the memory 630, may comprise means for de-weighting the elevation mask information. In another example implementation, the method 1400 includes determining whether the elevation mask information for a particular location has converged. For example, the elevation mask unit 650 may determine whether or not an incremental change, due to an additional elevation mask data point, in a minimum elevation angle for LOS SVs for a particular location and azimuth angle is less than a threshold change. The processor 610, possibly in combination with the memory 630, may comprise means for determining whether the elevation mask information has converged. In a further example implementation, the method 1400 further includes transmitting, from the entity to a user equipment, an instruction not to report respective elevation mask information for the particular location, based on determining that the respective elevation mask information for the particular location has converged. For example, at sub-stage 1233 the network entity 600 may transmit the elevation mask information message 1234 with an implicit and/or explicit instruction not to report elevation mask information (e.g., for one or more specified azimuth angles) for a location (and azimuth angle(s)) for which the elevation mask information has converged.

### IMPLEMENTATION EXAMPLES

Implementation examples are provided in the following numbered clauses.

Clause 1. A method for use in positioning of a user equipment, the method comprisingx:
acquiring, at the user equipment, a first satellite vehicle signal from a first satellite vehicle of a plurality of satellite vehicles;
obtaining, at the user equipment, ephemeris data from the first satellite vehicle signal; and
providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

Clause 2. The method of clause 1, further comprising transmitting a positioning-quality indication, based on the ephemeris data and the plurality of elevation mask indications.

Clause 3. The method of clause 1, wherein providing the plurality of elevation mask indications comprises wirelessly transmitting the plurality of elevation mask indications from the user equipment to a network entity.

Clause 4. The method of clause 3, wherein transmitting the plurality of elevation mask indications comprises transmitting each of the plurality of elevation mask indications in response to determination of the elevation angle range of each of the plurality of elevation mask indications.

Clause 5. The method of clause 3, wherein transmitting the plurality of elevation mask indications comprises transmitting the plurality of elevation mask indications in response to one or more reporting criteria, specified by the network entity to the user equipment, being met.

Clause 6. The method of clause 5, wherein the one or more reporting criteria comprise at least one of: passage of a time interval; a specified amount of user equipment memory limit for storing the plurality of elevation mask indications being reached; acquisition or restoration of acceptable levels of connectivity of the user equipment to a network of the network entity; departure of the user equipment from a geographic region of interest; or convergence of the plurality of elevation mask indications.

Clause 7. The method of clause 1, further comprising providing a location-error indication based on a disparity between which of the plurality of satellite vehicles the plurality of elevation mask indications indicate are not visible at the location of the user equipment and which of the plurality of satellite vehicles are visible to the user equipment.

Clause 8. A user equipment comprising:
at least one satellite positioning system (SPS) receiver;
at least one memory; and
at least one processor communicatively coupled to the at least one SPS receiver and the at least one memory and configured to:
   acquire, via the at least one SPS receiver, a first satellite vehicle signal from a first satellite vehicle of a plurality of satellite vehicles;
   obtain ephemeris data from the first satellite vehicle signal; and
   provide, to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

Clause 9. The user equipment of clause 8, wherein the at least one processor is configured to transmit a positioning-quality indication, based on the ephemeris data and the plurality of elevation mask indications.

Clause 10. The user equipment of clause 8, further comprising at least one transmitter communicatively coupled to the at least one processor, wherein to provide the plurality of elevation mask indications the at least one processor is configured to wirelessly transmit the plurality of elevation mask indications from the user equipment to a network entity via the at least one transmitter.

Clause 11. The user equipment of clause 10, wherein to transmit the plurality of elevation mask indications the at least one processor is at least one of configured to transmit each of the plurality of elevation mask indications in response to determination of the elevation angle range of each of the plurality of elevation mask indications and configured to transmit the plurality of elevation mask indications in response to one or more reporting criteria, specified by the network entity to the user equipment, being met.

Clause 12. The user equipment of clause 8, wherein the at least one processor is configured to provide a location-error indication based on a disparity between which of the plurality of satellite vehicles the plurality of elevation mask indications indicate are not visible at the location of the user equipment and which of the plurality of satellite vehicles are visible to the user equipment.

Clause 13. A user equipment comprising:
means for acquiring a first satellite vehicle signal from a first satellite vehicle of a plurality of satellite vehicles;
means for obtaining ephemeris data from the first satellite vehicle signal; and
means for providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

Clause 14. The user equipment of clause 13, further comprising means for transmitting a positioning-quality indication, based on the ephemeris data and the plurality of elevation mask indications.

Clause 15. The user equipment of clause 13, wherein the means for providing the plurality of elevation mask indications comprise means for wirelessly transmitting the plurality of elevation mask indications from the user equipment to a network entity.

Clause 16. The user equipment of clause 15, wherein the means for transmitting the plurality of elevation mask indications comprise at least one of means for transmitting each of the plurality of elevation mask indications in response to determination of the elevation angle range of each of the plurality of elevation mask indications and means for transmitting the plurality of elevation mask indications in response to one or more reporting criteria, specified by the network entity to the user equipment, being met.

Clause 17. The user equipment of clause 13, further comprising means for providing a location-error indication based on a disparity between which of the plurality of satellite vehicles the plurality of elevation mask indications indicate are not visible at the location of the user equipment and which of the plurality of satellite vehicles are visible to the user equipment.

Clause 18. A non-transitory, processor-readable storage medium comprising processor-readable instructions to cause at least one processor of a user equipment to:
acquire a first satellite vehicle signal from a first satellite vehicle of a plurality of satellite vehicles;
obtain ephemeris data from the first satellite vehicle signal; and
provide to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

Clause 19. The non-transitory, processor-readable storage medium of clause 18, further comprising processor-readable instructions to cause the at least one processor to transmit a positioning-quality indication, based on the ephemeris data and the plurality of elevation mask indications.

Clause 20. The non-transitory, processor-readable storage medium of clause 18, wherein the processor-readable instructions to cause the at least one processor to provide the plurality of elevation mask indications comprise processor-readable instructions to cause the at least one processor to wirelessly transmit the plurality of elevation mask indications from the user equipment to a network entity.

Clause 21. The non-transitory, processor-readable storage medium of clause 20, wherein the processor-readable instructions to cause the at least one processor to transmit the plurality of elevation mask indications comprise at least one of processor-readable instructions to cause the at least one processor to transmit each of the plurality of elevation mask indications in response to determination of the elevation angle range of each of the plurality of elevation mask indications and processor-readable instructions to cause the at least one processor to transmit the plurality of elevation mask indications in response to one or more reporting criteria, specified by the network entity to the user equipment, being met.

Clause 22. The non-transitory, processor-readable storage medium of clause 18, further comprising processor-readable instructions to cause the at least one processor to provide a location-error indication based on a disparity between which of the plurality of satellite vehicles the plurality of elevation mask indications indicate are not visible at the location of the user equipment and which of the plurality of satellite vehicles are visible by the user equipment.

Clause 23. An elevation mask method comprising:
obtaining, at an entity, position information indicative of user equipment positions;
obtaining, at the entity, elevation mask information corresponding to the user equipment positions and indicative of satellite vehicle visibility, if any, in a respective elevation angle range for each of a respective plurality of azimuth directions for each of the user equipment positions; and
determining, at the entity, an elevation mask based on the elevation mask information.

Clause 24. The method of clause 23, wherein the entity is a network entity, the method further comprising transmitting, from the entity to a user equipment, an instruction to report respective elevation mask information.

Clause 25. The method of clause 23, wherein the entity is a network entity, the method further comprising transmitting, from the entity to a user equipment, an instruction to report respective elevation mask information in response to one or more reporting criteria being met.

Clause 26. The method of clause 25, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

Clause 27. The method of clause 23, wherein determining the elevation mask comprises mapping a first location estimate of a user equipment corresponding to a portion of the elevation mask information to a second location in the elevation mask.

Clause 28. The method of clause 27, further comprising assigning weightage to the portion of the elevation mask information based on a relationship of the first location estimate to the second location.

Clause 29. The method of clause 23, further comprising assigning weightage to the elevation mask information based on an elevation mask determination capability of a user equipment reporting the elevation mask information.

Clause 30. The method of clause 23, further comprising determining whether the elevation mask information for a particular location has converged.

Clause 31. The method of clause 30, further comprising transmitting, from the entity to a user equipment, an instruction not to report respective elevation mask information for the particular location, based on determining that the respective elevation mask information for the particular location has converged.

Clause 32. An apparatus comprising:
at least one receiver;
at least one memory; and
at least one processor communicatively coupled to the at least one receiver and the at least one memory and configured to:
   obtain position information indicative of user equipment positions;
   obtaining elevation mask information corresponding to the user equipment positions and indicative of satellite vehicle visibility, if any, in a respective elevation angle range for each of a respective plurality of azimuth directions for each of the user equipment positions; and
   determine an elevation mask based on the elevation mask information.

Clause 33. The apparatus of clause 32, wherein the apparatus is a network entity and comprises at least one transmitter communicatively coupled to the at least one processor, and wherein the at least one processor is configured to transmit, via the at least one transmitter to a user equipment, an instruction to report respective elevation mask information.

Clause 34. The apparatus of clause 32, wherein the apparatus is a network entity and comprises at least one transmitter communicatively coupled to the at least one processor, and wherein the at least one processor is configured to transmit, via the at least one transmitter to a user equipment, an instruction to report respective elevation mask information in response to one or more reporting criteria being met.

Clause 35. The apparatus of clause 34, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

Clause 36. The apparatus of clause 32, wherein to determine the elevation mask the at least one processor is configured to map a first location estimate of a user equipment corresponding to a portion of the elevation mask information to a second location in the elevation mask.

Clause 37. The apparatus of clause 36, wherein the at least one processor is configured to de-weight the portion of the elevation mask information based on a separation of the first location estimate and the second location.

Clause 38. The apparatus of clause 32, wherein the at least one processor is configured to de-weight the elevation mask information based on an elevation mask determination capability of a user equipment reporting the elevation mask information.

Clause 39. The apparatus of clause 32, wherein the at least one processor is configured to determine whether the elevation mask information for a particular location has converged.

Clause 40. The apparatus of clause 39, further comprising at least one transmitter communicatively coupled to the at least one processor, wherein the at least one processor is configured to transmit, via the at least one transmitter to a user equipment, an instruction not to report respective elevation mask information for the particular location, based on determining that the respective elevation mask information for the particular location has converged.

Clause 41. An apparatus comprising:
means for obtaining position information indicative of user equipment positions;
means for obtaining elevation mask information corresponding to the user equipment positions and indicative of satellite vehicle visibility, if any, in a respective elevation angle range for each of a respective plurality of azimuth directions for each of the user equipment positions; and
means for determining an elevation mask based on the elevation mask information.

Clause 42. The apparatus of clause 41, wherein the apparatus is a network entity, and the apparatus further comprises means for transmitting, to a user equipment, an instruction to report respective elevation mask information.

Clause 43. The apparatus of clause 41, wherein the apparatus is a network entity, and the apparatus further comprises means for transmitting, to a user equipment, an instruction to report respective elevation mask information in response to one or more reporting criteria being met.

Clause 44. The apparatus of clause 43, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

Clause 45. The apparatus of clause 41, wherein the means for determining the elevation mask comprise means for mapping a first location estimate of a user equipment corresponding to a portion of the elevation mask information to a second location in the elevation mask.

Clause 46. The apparatus of clause 45, further comprising means for de-weighting the portion of the elevation mask information based on a separation of the first location estimate and the second location.

Clause 47. The apparatus of clause 41, further comprising means for de-weighting the elevation mask information based on an elevation mask determination capability of a user equipment reporting the elevation mask information.

Clause 48. The apparatus of clause 41, further comprising means for determining whether the elevation mask information for a particular location has converged.

Clause 49. The apparatus of clause 48, further comprising means for transmitting, to a user equipment, an instruction not to report respective elevation mask information for the particular location, based on determining that the respective elevation mask information for the particular location has converged.

Clause 50. A non-transitory, processor-readable storage medium comprising processor-readable instructions to cause at least one processor of an apparatus to:
obtain position information indicative of user equipment positions;
obtain elevation mask information corresponding to the user equipment positions and indicative of satellite vehicle visibility, if any, in a respective elevation angle range for each of a respective plurality of azimuth directions for each of the user equipment positions; and
determine an elevation mask based on the elevation mask information.

Clause 51. The non-transitory, processor-readable storage medium of clause 50, wherein the apparatus is a network entity, and the non-transitory, processor-readable storage medium further comprises processor-readable instructions to cause the at least one processor to transmit, to a user equipment, an instruction to report respective elevation mask information.

Clause 52. The non-transitory, processor-readable storage medium of clause 50, wherein the apparatus is a network entity, and the non-transitory, processor-readable storage medium further comprises processor-readable instructions to cause the at least one processor to transmit, to a user equipment, an instruction to report respective elevation mask information in response to one or more reporting criteria being met.

Clause 53. The non-transitory, processor-readable storage medium of clause 52, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

Clause 54. The non-transitory, processor-readable storage medium of clause 50, wherein the processor-readable instructions to cause the at least one processor to determine the elevation mask comprise processor-readable instructions to cause the at least one processor to map a first location estimate of a user equipment corresponding to a portion of the elevation mask information to a second location in the elevation mask.

Clause 55. The non-transitory, processor-readable storage medium of clause 54, further comprising processor-readable instructions to cause the at least one processor to de-weight the portion of the elevation mask information based on a separation of the first location estimate and the second location.

Clause 56. The non-transitory, processor-readable storage medium of clause 50, further comprising processor-readable instructions to cause the at least one processor to de-weight the elevation mask information based on an elevation mask determination capability of a user equipment reporting the elevation mask information.

Clause 57. The non-transitory, processor-readable storage medium of clause 50, further comprising processor-readable instructions to cause the at least one processor to determine whether the elevation mask information for a particular location has converged.

Clause 58. The non-transitory, processor-readable storage medium of clause 57, further comprising processor-readable instructions to cause the at least one processor to transmit, to a user equipment, an instruction not to report respective elevation mask information for the particular location, based on determining that the respective elevation mask information for the particular location has converged.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.).

Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method for use in positioning of a user equipment, the method comprising:
acquiring, at the user equipment, a first satellite vehicle signal from a first satellite vehicle of a plurality of satellite vehicles;
obtaining, at the user equipment, ephemeris data from the first satellite vehicle signal; and
providing to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

2. The method of claim 1, further comprising transmitting a positioning-quality indication, based on the ephemeris data and the plurality of elevation mask indications.

3. The method of claim 1, wherein providing the plurality of elevation mask indications comprises wirelessly transmitting the plurality of elevation mask indications from the user equipment to a network entity.

4. The method of claim 3, wherein transmitting the plurality of elevation mask indications comprises transmitting each of the plurality of elevation mask indications in response to determination of the elevation angle range of each of the plurality of elevation mask indications.

5. The method of claim 3, wherein transmitting the plurality of elevation mask indications comprises transmitting the plurality of elevation mask indications in response to one or more reporting criteria, specified by the network entity to the user equipment, being met.

6. The method of claim 5, wherein the one or more reporting criteria comprise at least one of: passage of a time interval; a specified amount of user equipment memory limit for storing the plurality of elevation mask indications being reached; acquisition or restoration of acceptable levels of connectivity of the user equipment to a network of the network entity; departure of the user equipment from a geographic region of interest; or convergence of the plurality of elevation mask indications.

7. The method of claim 1, further comprising providing a location-error indication based on a disparity between which of the plurality of satellite vehicles the plurality of elevation mask indications indicate are not visible at the location of the user equipment and which of the plurality of satellite vehicles are visible to the user equipment.

8. A user equipment comprising:
at least one satellite positioning system (SPS) receiver;
at least one memory; and
at least one processor communicatively coupled to the at least one SPS receiver and the at least one memory and configured to:
acquire, via the at least one SPS receiver, a first satellite vehicle signal from a first satellite vehicle of a plurality of satellite vehicles;
obtain ephemeris data from the first satellite vehicle signal; and
provide, to an entity, based at least on the ephemeris data, a plurality of elevation mask indications corresponding to a location of the user equipment and each indicating an azimuth direction and an elevation angle range, if any, of potential satellite vehicle visibility in the indicated azimuth direction.

9. The user equipment of claim 8, wherein the at least one processor is configured to transmit a positioning-quality indication, based on the ephemeris data and the plurality of elevation mask indications.

10. The user equipment of claim 8, further comprising at least one transmitter communicatively coupled to the at least one processor, wherein to provide the plurality of elevation mask indications the at least one processor is configured to wirelessly transmit the plurality of elevation mask indications from the user equipment to a network entity via the at least one transmitter.

11. The user equipment of claim 10, wherein to transmit the plurality of elevation mask indications the at least one processor is at least one of configured to transmit each of the plurality of elevation mask indications in response to determination of the elevation angle range of each of the plurality of elevation mask indications and configured to transmit the plurality of elevation mask indications in response to one or more reporting criteria, specified by the network entity to the user equipment, being met.

12. The user equipment of claim 8, wherein the at least one processor is configured to provide a location-error indication based on a disparity between which of the plurality of satellite vehicles the plurality of elevation mask indications indicate are not visible at the location of the user equipment and which of the plurality of satellite vehicles are visible to the user equipment.

13. An elevation mask method comprising:
obtaining, at an entity, position information indicative of user equipment positions;
obtaining, at the entity, elevation mask information corresponding to the user equipment positions and indicative of satellite vehicle visibility, if any, in a respective elevation angle range for each of a respective plurality of azimuth directions for each of the user equipment positions; and
determining, at the entity, an elevation mask based on the elevation mask information.

14. The method of claim 13, wherein the entity is a network entity, the method further comprising transmitting, from the entity to a user equipment, an instruction to report respective elevation mask information.

15. The method of claim 13, wherein the entity is a network entity, the method further comprising transmitting, from the entity to a user equipment, an instruction to report respective elevation mask information in response to one or more reporting criteria being met.

16. The method of claim 15, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

17. The method of claim 13, wherein determining the elevation mask comprises mapping a first location estimate of a user equipment corresponding to a portion of the elevation mask information to a second location in the elevation mask.

18. The method of claim 17, further comprising assigning weightage to the portion of the elevation mask information based on a relationship of the first location estimate to the second location.

19. The method of claim 13, further comprising assigning weightage to the elevation mask information based on an elevation mask determination capability of a user equipment reporting the elevation mask information.

20. The method of claim 13, further comprising determining whether the elevation mask information for a particular location has converged.

21. The method of claim 20, further comprising transmitting, from the entity to a user equipment, an instruction not to report respective elevation mask information for the particular location, based on determining that the respective elevation mask information for the particular location has converged.

22. An apparatus comprising:
at least one receiver;
at least one memory; and
at least one processor communicatively coupled to the at least one receiver and the at least one memory and configured to:
obtain position information indicative of user equipment positions;
obtaining elevation mask information corresponding to the user equipment positions and indicative of satellite vehicle visibility, if any, in a respective elevation angle range for each of a respective plurality of azimuth directions for each of the user equipment positions; and
determine an elevation mask based on the elevation mask information.

23. The apparatus of claim 22, wherein the apparatus is a network entity and comprises at least one transmitter communicatively coupled to the at least one processor, and wherein the at least one processor is configured to transmit, via the at least one transmitter to a user equipment, an instruction to report respective elevation mask information.

24. The apparatus of claim 22, wherein the apparatus is a network entity and comprises at least one transmitter communicatively coupled to the at least one processor, and wherein the at least one processor is configured to transmit, via the at least one transmitter to a user equipment, an instruction to report respective elevation mask information in response to one or more reporting criteria being met.

25. The apparatus of claim 24, wherein the one or more reporting criteria comprise at least one of: passage of a time interval; a specified amount of memory for the user equipment to use to store the respective elevation mask information; acceptable connectivity of the user equipment to a network of the network entity; departure of the user equipment from a specific geographic region; or convergence of the respective elevation mask information.

26. The apparatus of claim 22, wherein to determine the elevation mask the at least one processor is configured to map a first location estimate of a user equipment corresponding to a portion of the elevation mask information to a second location in the elevation mask.

27. The apparatus of claim 26, wherein the at least one processor is configured to de-weight the portion of the elevation mask information based on a separation of the first location estimate and the second location.

28. The apparatus of claim 22, wherein the at least one processor is configured to de-weight the elevation mask information based on an elevation mask determination capability of a user equipment reporting the elevation mask information.

29. The apparatus of claim 22, wherein the at least one processor is configured to determine whether the elevation mask information for a particular location has converged.

30. The apparatus of claim 29, further comprising at least one transmitter communicatively coupled to the at least one processor, wherein the at least one processor is configured to transmit, via the at least one transmitter to a user equipment, an instruction not to report respective elevation mask information for the particular location, based on determining that the respective elevation mask information for the particular location has converged.
